(19) United States
(12) Patent Application Publication
(10) Pub. No.: US 2023/0023714 A1
(43) Pub. Date: Jan. 26, 2023

(54) Informational Card Devices That Display Digital Image Content

(71) Applicant: Aquanetta Walker, Los Angeles, CA (US)

(72) Inventor: Aquanetta Walker, Los Angeles, CA (US)

(21) Appl. No.: 17/871,527

(22) Filed: Jul. 22, 2022

Related U.S. Application Data
(60) Provisional application No. 63/203,440, filed on Jul. 22, 2021.

(51) Int. Cl. G06F 3/14

(52) U.S. Cl. CPC G06F 3/1423

(57) ABSTRACT

Embodiments of this invention provide devices with image displays that show digital image content (e.g., animations, pictures, in-motion images, slide shows, videos and audio) to one or more observers. Some of the preferred embodiments of this invention are devices that are rectangularly shaped and that comprise one or more digital video screen components connected to a computer device that is connected to at least one memory device and one or more input devices. The device can be handheld and, in the most preferred embodiments, is the size of a business card, post card, or greeting card, although smaller and larger sizes can be used for different applications.

### RELATED APPLICATIONS

This application claims the benefit of a US patent application that was filed on Jul. 22, 2021 as U.S. Ser. No. 63/203,440, which application is incorporated by reference herein in its entirety.

### FIELD OF THE INVENTION

The invention relates to informational cards that display digital image content.

### BACKGROUND OF THE INVENTION

The use of informational cards for recreation and business applications can be useful but they suffer from not being engaging to the observer. In addition, the informational cards used in the past only provided a very limited amount of content on the card. Such cards would be greatly improved if they could be more engaging and provide a larger amount of content to hold the observer's attention and provide more information. Improved informational cards are thus needed that can be more engaging, provide more content, hold the observer's attention, and provide more information to the observer.

### SUMMARY OF THE INVENTION

Embodiments of this invention provide devices with image displays that show digital image content (e.g., animations, pictures, in-motion images, slide shows, videos and audio) to one or more observers. Some of the preferred embodiments of this invention are devices that are rectangularly shaped and that comprise, within the card, one or more digital video screen components connected to a computer device that is connected to at least one memory device and one or more input devices. The device can be handheld (e.g., be portable) and, in the most preferred embodiments, is the size of a business card, post card, or greeting card, although smaller and larger sizes can be used for different applications.

Particularly preferred embodiments of this invention comprise digital, animated, video and audio, picture, slide show, and/or in-motion displays of information. These preferred embodiments may have informational, business, professional, and/or personal and other applications. Some preferred embodiments include but are not limited to business cards, post cards, reusable calendar cards, magazine inserts, and/or greeting and other informational cards, among many other applications.

In the most preferred embodiments, an informational card device that is capable of displaying digital image content is provided by this invention. The informational card comprises: (a) one or more digital video screen components, which are devices that are capable of displaying digital image content for an observer to see; (b) one or more input devices, which are devices that are capable of receiving digital image content and sending it to one or more computer devices; (c) one or more memory devices, which are devices that are capable of storing digital image content after receiving such from the one or more computer devices; (d) the one or more computer devices, which are capable of receiving the input of digital image content from the one or more input devices, which are capable of outputting the digital image content to the one or more memory devices, and which are capable of retrieving the digital image content from the one or more memory devices and sending it to the one or more digital video screen components; (e) one or more control devices, which are capable of turning the informational card device on; and (f) wherein once the informational card device is turned on, the one or more computer devices retrieves the digital image content from the one or more memory devices and sends it to the one or more digital video screen components for display to the observer. The type of informational card device is of many different possible types usable in many different applications. The preferred informational card devices are selected from the group consisting of business cards, post cards, greeting cards, calendar cards, card attachments to dishes, card attachments to clothing, card attachments to kid's toys, card attachments to wallets, card attachments to school supplies, or card attachments to key chains, among other applications where presenting digital image content may provide benefits to the user. The informational card device is most preferably portable, self-contained (e.g., in use it does not need to be plugged in or connected to wires to anything else) and of a size of less than about W12″×L12″ (where W means width and L means length), or with a digital video screen component of less than about W12″ and L 12″, and less than about ½″ thick.

In the business card, post card, greeting card, magazine insert card, and other similar applications of this invention, the informational card devices are processed by the user to provide information concerning the user or a topic (e.g., subject matter) of interest to the user, and once completed, are given away to an observer as the intended recipient of the information concerning the user or a topic of interest to the user. This digital image content is provided by the user, or for the benefit of the user, to the observer. In other words, in these particular applications, the user is preparing the device to be used by another person or persons, i.e., the observer or the observers. For example, by using the term “business card” herein, the inventor is referring to a new device that may replace the use of traditional paper “business cards” that are handed out to people of interest without charge and without expectation of having them returned.

In certain applications, it is preferred that the device of this invention have a relatively thin thickness (note: in describing sizes herein, “approximately” and “about” are used as synonymous terms, and the double quotation punctuation mark (i.e., “) refers to inches). Thus, in the business card application of this invention, as an example, a thickness of about ⅛″ or less is preferred, although other thicknesses can be used. In general, in the applications of this invention, a preferred range of the thicknesses of the devices is about 1/16″ to about ½″, a more preferred range is about 1/16″ to about 3/16″, and a most preferred range is about 1/16″ to about ⅛″ for each device, although other thicknesses (e.g., greater, varied within the device, etc.) can be used.

In the preferred embodiments, the devices of this invention are portable and the size and shape of the face of the devices visible to the observer when being used (e.g., the digital video screen component) are less than about W12″×L12″, although other sizes and shapes can be used.

### BRIEF DESCRIPTION OF THE DRAWINGS

FIG. 1 shows a schematic of an embodiment of a business card application of this invention with a front and back view. In this embodiment, the front displays textual information and the back is playing a video.

FIG. 2 shows a schematic of a different embodiment of a business card appliction of this invention with a front and back view, each of the front and the back playing a video.

FIG. 3 shows a schematic of an embodiment of a post card applicationof this invention with a front view, back view, and inside of flap view.

FIG. 4 shows a schematic of an embodiment of a greeting card application of this invention with a front view of an envelope, a back view of an envelope, and a front view of the greeting card with a digital video screen component that is the entire size of the front of the greeting card.

FIG. 5 shows a schematic of an embodiment of a calendar card application of this invention with a front view with a digital video screen component on the top part and a white board calendar form on the bottom part.

FIG. 6 shows a schematic of an embodiment of a calendar card application of this invention with a back view with and adhesive strip and hanging hardware on the top.

FIG. 7 shows a schematic of an embodiment of a magazine insert card application of this invention with a front view of the insert attached to the seam of the magazine, with the magazine shown open with a left side and a right side.

FIG. 8 shows schematics of two embodiments of the invention, namely a mug and a T-Shirt, each of which have at least one digital video screen component of this invention.

FIG. 9 shows schematics of one embodiment of the invention, namely a cap, which has two digital video screen components of this invention.

FIG. 10 shows schematics two embodiments of the invention, namely a doll (e.g., teddy bear), and an inside view of a wallet, each of which have at least one digital video screen component of this invention.

FIG. 11 shows schematics two embodiments of the invention, namely a notebook (e.g., a notebook/journal for school), and a key chain, each of which have at least one digital video screen component of this invention.

### DETAILED DESCRIPTION OF THE INVENTION

### The Devices of this Invention

Embodiments of this invention provide devices for displaying informational content and methods of making and methods of using them on cards. The devices are preferably informational cards that display digital image content to an observer. The informational cards of this invention in certain embodiments preferably comprise a rectangularly shaped device, although other shapes can be used, that comprise at least one digital video screen component connected to at least one attached or otherwise connected computer device comprising at least one memory device and one or more input device. Preferred embodiments of the device can be handheld and are portable, and, in the most preferred embodiments, are the size of a business card, post card, or greeting card, although smaller and larger sizes can be used for different applications. The use of the word “card” herein is not meant to be limiting, but it is meant to convey that a “card” is a portable device that is not relatively thick (e.g., a preferred range of thickness is about 1/16″ to about ½″ but other thicknesses can be used). Rather, the device in preferred embodiments may have a similar size and shape to business cards, post cards, or greeting cards, but in other embodiments other shapes and sizes can be used.

The at least one digital video screen component of this invention presents or otherwise displays digital image content on a screen to an observer. As used herein, “digital image content” at least includes animations, pictures, in-motion images, slide shows, and/or videos, wherein this latter term “videos” includes sound or audio played on one or more speakers on the device or on one of the components of the device.

The digital video screen components that are used preferentially present information in color, although such digital video screen components that present black and white content can also be used. The digital video screen components that are used preferentially have a resolution for presenting the digital information that is appropriate for the viewing of the content being displayed. For example, higher resolution may be of benefit in the display of detailed images, while in other applications less resolution may be acceptable and be more economical to provide in a small form.

The digital video screen components that are used are preferentially rectangular shaped, although other shapes can be used. The digital video screen components that are used are preferentially thin, with 0.125 (⅛″) of an inch being most preferred, although other widths may be used. The most preferred sizes and shapes of the digital video screen components are the sizes of business cards, post cards, and greeting cards, although other sizes and shapes can be used.

Possible specifications that can be used for the digital video screen components may vary. An unlimiting example could be a screen size of 2.4″; a resolution of 320×240; an aspect ratio of 4:3; dimensions of 48 mm×36 mm; diagonal length of 61 mm; video code of MJPEG, yuv420p; media formats of AVI, 25-30 fps; bit rates of 700 kbit/s or higher; audio of MP3, 220 Hz, stereo, 24 kb/s.

In the most preferred embodiments, one digital video screen component is used per device. In other embodiments two or more digital video screen components can be provided in one device in order to present different information or have different information being displayed juxtaposed against one another or separately from one another.

The content that is to be displayed on the device is stored in memory in the digital video screen component, or most preferably, in one or more memory devices connected to one or more computer devices. The memory devices (e.g., 2 GB, or more (or less) storage, depending on the needs of the application) are used to store instructions and/or content for the playing of the digital image content on the digital video screen components. In the most preferred embodiments, at least one computer device is connected to the one or more memory devices and the computer devices are responsible for accessing (retrieving) the digital image content stored on the memory devices and providing it to the digital video screen components to display it to the observer.

The digital image content that is to be displayed on the device may be added to the device when it is being manufactured. In certain preferred embodiments it is flashed into memory available on the digital video screen component and/or it is flashed into the one or more memory devices that are connected to the at least one computer device.

In alternative embodiments, the digital image content can be updated and/or added to the devices by the user who is preparing the devices to be used by one or more observers of the content. In these embodiments, the devices have one or more input devices for updating and/or changing instructions and/or digital image content that is to be displayed. These input devices can be connected directly to, or be part of, the digital video screen components, or they can be connected directly to, or be part of, the computer devices that are connected to the digital video screen components, and also to the one or more memory devices for storing the instructions and/or digital image content.

These input devices can comprise one or more wired connections, such as USB connections or SD card connections or other such connections, and/or these input devices can comprise one or more wireless connections, such as using an antenna and a Bluetooth or other wireless connection. Other wired and wireless connections are known to a person skilled in the art that can be used to provide instructions and/or digital image content to the device for displaying it to an observer on the one or more digital video screen components. In some embodiments, these input devices may also be used to charge and/or recharge energy sources (e.g., batteries) used by the device.

In certain of the most preferred embodiments, the digital image content can be changed and/or updated, making the devices updateable, reusable and/or recyclable.

In some preferred embodiments, the device may comprise one or more digital video screen components. In other preferred embodiments, the device comprises a housing that includes the one or more digital video screen components. In other preferred embodiments, the device comprises a housing that includes one or more digital video screen components, one or more computer devices, one or more memory devices, and/or one or more input devices. One of skill in the art will understand that various combinations of these components in these embodiments can be used to make different combinations of components and embodiments of this invention.

In addition, the device may comprise one or more control devices. These control devices may be directly attached to the housings, the computer devices and/or the digital video screen components. The control devices are connected to the devices' components in order to facilitate the use of the device by the observer and/or the user that is preparing the device for the observer. A person of skill in the art will understand that many different types of control devices can be used. These would include but not be limited to on/off switches, buttons (e.g., playback, pause, advance, rewind, lower volume, increase volume, change screen intensity), toggles, tactile responsive screens (e.g., touch screens) and buttons, temperature activated buttons (e.g., that respond to finger touches or proximity), scanners, reset buttons, motion sensors, other switches, light intensity detectors, and other such control devices used to control digital devices and/or the playback of images such as video (and sound). In some preferred embodiments, the device is turned on by squeezing either end of the tip of the card, which then begins the display of digital image content with any messages on the digital video screen components.

One of skill in the art will see that different combinations of components and housings can be used pursuant to the description provided herein. Thus, in some preferred embodiments, the device comprises a housing that contains the one or more digital video screen components. In other preferred embodiments, the device comprises the housing and it also comprises one or more computer devices connected to the digital video screen components, one or more memory devices connected to the digital video screen components and/or the one or more computer devices, and one or more input devices connected to the digital video screen components and/or the one or more computer devices. The control devices can be on the housings, the digital video screen components, or elsewhere, and they will be electrically connected to the components that they control. In other embodiments, the digital video screen component is self-contained and any other separate components are contained within the digital video screen component itself.

In addition, in certain of the most preferred embodiments, the device comprises a digital video screen component that may or may not be in a housing. In some of these embodiments, the digital video screen component may comprise one or more memory devices, one or more input devices and one or more computer devises that are built into it. In certain other most preferred embodiments, the device comprises digital video screen components connected to one or more computer devices. In some of these embodiments, the one or more computer devices are connected to one or more memory devices and one or more input devices. Other combinations are readily discernable to a person of skill in the art.

The devices of this invention are portable and certain preferred embodiments contain an energy source to playback the digital image content. In certain of the most preferred embodiments, the devices contain small, thin batteries that are electrically connected to the other components that are provided (e.g., digital video screen components, computer devices, memory devices, input devices, control devices (on/off switches), speakers). In certain of the most preferred embodiments, the batteries are built into housings for the devices and/or directly into the digital video screen components.

Other components can be used with the devices of this invention. This includes a sleeve and/or other covering to keep the devices protected. It can also include components from modern credit cards and mobile phones, like memory and identification features, and/or the tap features, of credit cards, the fingerprint sensor and/or the sharing feature of certain mobile phones when they are placed next to one another or stacked together.

One of skill in the art will understand how to construct embodiments of this invention. In one such method, a digital video screen component is acquired. It is used on its own, or in a housing (e.g., made of plastic, metal, wood, cardboard, or a combination of these), or contained in a sleeve or other container, and also connected to an energy source, such as a battery (e.g., a battery than can be recharged with a USB input). In some embodiments the digital video screen component of a particular card application is electrically and physically connected to one or more computer devices, one or more memory devices, one or more input devices, one or more control devices, on or more energy sources (e.g., a battery or USB device), and/or one or more speakers. The instructions and/or digital image content are flashed or otherwise input into the device as described above. The devices are then distributed to potential observers. In certain embodiments, the components of the devices of this invention are all placed within the digital video screen component and separate housings and connections for the components are not used. In other embodiments, a digital video screen component is attached to a circuit board with the other components (e.g., computer device, memory device, input device, speaker(s)), optionally protected with a covering, and used in this form. A person of skill in the art will understand there are other configurations and methods that can be applied to make the devices of this invention.

### General Applications of the Devices

Particularly preferred embodiments of this invention provide displays of animations, pictures, in-motion images, videos (with sound), and slide show displays of information. These preferred embodiments may have informational, business, professional, and/or personal and other applications. Some preferred embodiments include but are not limited to business cards (e.g., the devices of this invention may replace the current paper business cards and the devices of this invention are of a size that they may be clipped or otherwise attached to resumes), post cards, reusable calendar cards, magazine inserts, and/or greeting and other informational cards. Certain preferred embodiments of this invention provide digital, animated, video, in-motion images, business, professional and personal cards; post cards; reusable calendar cards; magazine insert video cards; greeting cards; and other applications.

This invention is unique, and its preferred embodiments serve a purpose to enhance people's lives with a goal to improve relationships, regardless of whether the relationships are professional or personal. The preferred embodiments of these video business card, animated business cards, in-motion business cards, and digital business cards, will make more effective business cards, as one example.

When applied to business cards, as an example, certain embodiments of this invention provide digital image content (e.g., digital video) to business or calling cards for business or personal use that are not like any other business card because they offer so much more. The regular paper business card has a limited amount of space and limited information on it and thus it is limited in how it can serve clients, customers, and others. People have only a few seconds to capture someone's attention. Most of the paper business cards are thrown in the trash. Few people are fortunate enough to wow someone in a few seconds. Most people either do not or cannot. With the animated business cards, post cards, greeting cards, and other applications of this invention, one may obtain a captive audience for at least a few seconds, a minute, or even more time. A minute is a long time to make a great first impression.

This invention presents not only a user's contact information but gives the user an edge over everyone else because a video explaining the user's skills, experience and what the user can bring to the table can be uploaded onto the card through a mechanism that is embedded inside the card and thus it can be displayed on the screen. The recipient can listen to the information in his/her office, his/her car, at home, walking the dog, etc., pique his/her interest and can encourage them to make a decision about the person(s), company, organization, etc. before he/she gets to his/her car, gets home and or back to the office. This invention helps the candidates, etc., navigate more successfully through red tape and can speed up the process of hiring decisions, investors, nominations, whatever you are searching for, applying for, etc. It showcases the user's talents and skills and provides what the user has to offer and why they are the best and gives the recipient a sense of who the user is, which is something a paper business card or paper resume cannot provide, not to mention the fact that cards and resumes get lost and they often drop through the cracks of a busy/hectic day.

Embodiments of this invention can be applied in various professional and personal situations. On a professional level, the video/animated/in-motion/digital business card is excellent for prospective employees, artists, graphic designers, musicians, singers, realtors, contractors, medical and engineering, programming, etc., and others. A singer, actor and musician cannot put his/her voice and music on a paper business card. The video business card showcases their talent and allows them to elaborate on their skills. Realtors and contractors can give virtual tours of homes and construction contractors can show the homes before and after work is completed. Artists can showcase their artwork. Doctors/surgeons can showcase samples of their surgeries. Many can benefit from the enhanced form of communication with this business card and thus there are many uses that can be improved by this invention.

The digital/video/in-motion post card application of this invention works in a similar manner to the business card application except it may be provided with a larger screen with extra memory and thus more display options, including time. This also can work as a calling card as well as personally, such as for all holidays, special occasions, personal messages to family and friends, graduations, retirements, personal thank you videos/digital messages, all kinds of occasions, vacations, funerals, be sent with flowers (in collaboration with florists as well other companies that send other types of gifts). Examples of some of the uses of these applications include using the invention to provide information on athletic wear, sports shirts, different caps, athletic shoes, dishes, linen, purses, wallets, books, notebooks, journals, school supplies, kid's toys, and teddy bears, but other uses are within the scope of this invention.

The business card, post card, greeting card, and calendar applications of this invention, as well as other applications, preferably use the same components/mechanisms. Thus, in preferred embodiments, the post card screen is activated in the same way as in the business card embodiments, for example, with the touch of the screen, the edge of the screen, or the top or bottom tip of the card, just like with the preferred business card embodiments.

The subject matter of this disclosure is now described with reference to the following examples. These examples are provided for the purpose of illustration only, and the subject matter is not limited to these examples, but rather encompasses all variations which are evident as a result of the teaching provided herein.

### EXAMPLE 1: BUSINESS CARD APPLICATIONS

Certain embodiments of this invention include a business card sized application Embodiments of the business card application are a device that includes at least one digital video screen component for displaying digital image content. Other components may include one or more computer devices, one or more memory devices, and/or one or more input devices to load and store the digital image content and/or instructions on the device, and then transfer the digital image content to the at least one digital video screen component for eventual display. The device may also include one or more control devices that are used to, for example, turn it on and off, and a housing to attach and/or connect all of the components. Alternatively, the at least one digital video screen components may have all of the other components built into it, including any computer devices, any memory devices, any input devices, and any control devices, and thus it will not include a separate houseing.

The business card applications of this invention are devices that are preferably the size of a credit card. In some embodiments, the business card application is thicker than many such credit cards in common use, in order to house and protect the components of the card (e.g., a digital video screen component, a computer device, a memory device, and/or an input device, if they are used). The material of the digital business card preferably will comprise a paper, cardboard, coated cardboard, and/or plastic housing. Other materials can be used.

In certain preferred embodiments of the front of the business card application of this invention, a potential user is provided with several several different digital video screen component location and size options to choose from, along with possible space made available for typed contact information or any other information one would want to put on the card, as well as featured artwork or logos. Thus the possible digital video screen component location and size can be anywhere on the card, in the middle, on the upper left corner, taking up one half of the card, etc. In particularly preferred embodiments, all of the available space on the front of the card is used for the digital video screen component.

In use, the business card applications of this invention can be activated by the observer (e.g., by touching or pushing a button, touching an edge or tip, etc.). Once the card is activated, the digital image content is displayed on the digital video screen component, and the card “comes to life” for approximately several seconds to several minutes depending on what images, messages, logos, vision, videos, one is sharing with their potential clients, family, friends, colleagues, teammates, etc., and the amount of memory on board the device.

The options chosen by the user preparing the card are entirely up to them, depending on one's needs, such as a slide presentation, a singer performing, a musician, a dancer, a presentation using a chart, whatever skills/talents/information a person/company is showcasing. The size of the digital screen components for the cards is in direct relation to the size of the business card and where the components are located inside any housing for the card. This relates to the options of the templates having the mechanism inside the card flexible to change in relation to the size and the location of the desired digital video screen component.

As stated above, the size and location of the digital video screen component on the cards can be presented in different scenarios, with or without available space for typed information on the front with contact or other information. As another embodiment, one can also choose to have digital video screen component displaying a video on the front, and a second digital video screen component on the back displaying a slide presentation. Another embodiment is to have the slide presentation on the front with the contact information and a video on the back. Another embodiment of the card offers a scrolling effect of the user's skills and experience on a screen. Another embodiment displays a slide presentation on the back of the card showing artwork on one side and the speaker's picture on the left. Another embodiment displays a slide show on the front and a speaker's picture on the back. Still another embodiment displays a speaker's picture on the front and a slide presentation on the back of the card. Other arrangements will be understood by a person of skill in the art after reading this specification.

In one scenario, customers can order the cards online and choose from pre-designed cards/templates with options available so they can customize their cards. In this scenario, the user can mix and match different formats. For example, one choice may be the size of the cards, starting at about 3.5″×2″, or larger or smaller, the location of any text (e.g., name and address information), and the size and location of the digital video screen component or components.

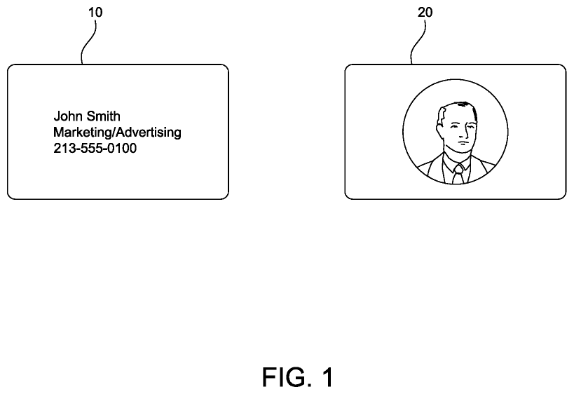

FIG. 1 shows a schematic of a front 10 and back 20 view of an embodiment of a business card application of this invention. On the front 10 side, the name and address of a user is printed. On the back 20 side, a video of the user is playing on a digital video screen component.

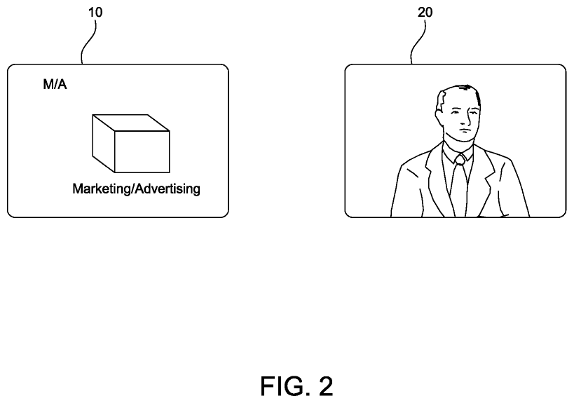

FIG. 2 shows a schematic of a front 10 and back 20 view of an embodiment of a business card application of this invention. On the front 10 side, a video concerning the user's company M/A is playing on a first digital video screen component. On the back 20 side, a different video of the user is playing on a second digital video screen component.

In certain of the most preferred embodiments, the business card application device of this invention is capable of displaying digital image content, the digital image content comprising animations, pictures, in-motion images, slide shows, and video and audio. These embodiments of the business card device comprise (a) a size of approximately 2″×3.5″ and are approximately 3/16 of an inch thick; (b) a digital video screen component, which is capable of displaying the digital image content for an observer to see; (c) an input device, which is capable of receiving the digital image content and sending it to a computer device; (d) a memory device, which is capable of storing the digital image content after receiving such from the computer device; (e) the computer device, which is capable of receiving the input of digital image content from the input device, which is also capable of outputting the digital image content to the memory device, and which is also capable of retrieving the digital image content from the memory device and sending it to the digital video screen component; (e) a control device, which is capable of turning the business card device on; and (f) wherein once the business card device is turned on, the computer device retrieves the digital image content from the memory device and sends it to the digital video screen component for display to the observer. The business card device can be protected by an envelope or sleeve, the digital video screen component can be protected by a flap, or some other variations can be provided.

In addition, to avoid any doubt, in the business card applications of this invention, the informational card devices are processed by the user to provide information concerning the user or a topic (e.g., subject matter) of interest to the user, and once completed, are given away to an observer as the intended recipient of the information concerning the user or a topic of interest to the user. In other words, in these particular applications, the user is preparing the device to be used by another person or persons, i.e., the observer or the observers. For example, by using the term “business card” herein, the inventor is referring to a new device that may replace the use of traditional paper “business cards” that are handed out to people of interest without charge and without expectation of having them returned. The inventor is not referring to a tool a user may use personally in their business or personal life—i.e., the business card devices of this invention are intended to be used by observers.

The user can hand the business card device to a potential observer, and, because it is self-contained (e.g., in use by the observer it does not need to be plugged in or connected to wires to anything else), the observer can hold it in their hands and observe the digital image content on the digital video screen component of the device.

### EXAMPLE 2: POST CARD APPLICATIONS

Certain embodiments of this invention include a post card sized application Embodiments of the post card application are a device that includes at least one digital video screen component for displaying digital image content. Other components may include one or more computer devices, one or more memory devices, and/or one or more input devices to load and store the digital image content and/or instructions on the device, and then transfer the digital image content to the at least one digital video screen component for eventual display. The device may also include one or more control devices that are used to, for example, turn it on and off, and a housing to attach and/or connect all of the components. Alternatively, the at least one digital video screen components may have all of the other components built into it, including any computer devices, any memory devices, any input devices, and any control devices, and thus it will not include a separate housing.

In this application of the invention, in the preferred embodiments, the digital video screen components would be larger in size than the screens used for the business card applications. A typical, but not limiting, dimension of a post card application would have preferred dimensions of approximately 3.18″×5.6″. The side dimensions, or thickness, of the post card applications, is preferably approximately 1/16″ to ⅛″ or larger to create room/space inside the card for the components.

In certain of the embodiments of this application, the front of the post card is provided with enough space to include address information, such as name, address, city and zip code. Some embodiments have a flap to cover the front of the card to protect (e.g., from the mailing and delivery process and any untoward weather) the at least one digital video screen component and also have an adhesive in the middle of the card to keep the flap closed. Other embodiments do not have the flap but instead use a separate envelope to send the post card.

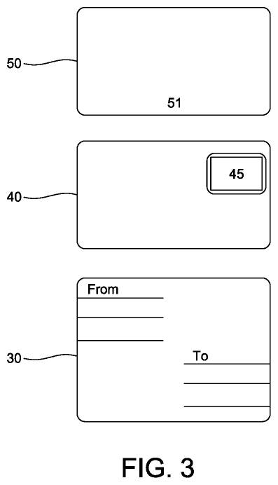

FIG. 3 shows a schematic of an embodiment of a post card application of this invention with a front 30 view, back 40 view, and inside of flap 50 view. A digital video screen component 45 is shown on the back 40 view. This digital video screen component 45 in this embodiment is realtively small. The digital video screen component in other embodiments can be of various sizes, including a size that takes up the entire back 40 of the post card. The flap 50 is fixedly attached to the post card by a hinge (not shown) and it can be folded down over the back 40 of the post card to protect the digital video screen component 45 while the process of mailing and delivery is occuring. The flap 50 can be affixed by the user with tape, or a small adhesive patch 51 can be added to keep the flap closed until the observer is ready to lift up the flap 50 and observe the back 40 of the post card. One of skill in the art will understand that there are other ways to protect the device than the use of a flap, adhesive, etc.

In certain of the most preferred embodiments of the post card applications of this invention, the post card device is capable of displaying digital image content, the digital image content comprising animations, pictures, in-motion images, slide shows, and video and audio. The post card device comprises (a) a size of approximately 3.18″×5.6″ the device is approximately ⅛″ thick (other sizes can be used); (b) a digital video screen component, which is capable of displaying the digital image content for an observer to see; (c) an input device, which is capable of receiving the digital image content and sending it to a computer device; (d) a memory device, which is capable of storing the digital image content after receiving such from the computer device; (e) the computer device, which is capable of receiving the input of digital image content from the input device, which is also capable of outputting the digital image content to the memory device, and which is also capable of retrieving the digital image content from the memory device and sending it to the digital video screen component; (f) a control device, which is capable of turning the post card device on; and (g) wherein once the post card device is turned on, the computer device retrieves the digital image content from the memory device and sends it to the digital video screen component for display to the observer. The post card device can be protected by an envelope, the digital video screen component can be protected by a flap, held down by adhesive or otherwise in some embodiments, or some other variations can be provided.

In addition, to avoid any doubt, in the post card applications of this invention, the informational card devices are processed by the user to provide information concerning the user or a topic (e.g., subject matter) of interest to the user, and once completed, are given away to an observer as the intended recipient of the information concerning the user or a topic of interest to the user. In other words, in these particular applications, the user is preparing the device to be used by another person or persons, i.e., the observer or the observers. For example, by using the term “post card” herein, the inventor is referring to a new device that may replace the use of traditional paper “post cards” that are mailed out to people of interest without charge and without expectation of having them returned. The inventor is not referring to a tool a user may use personally in their business or personal life—i.e., the post card devices are intended to be used by observers.

The user can mail the post card device to a potential observer, and, because it is self-contained (e.g., in use by the observer it does not need to be plugged in or connected to wires to anything else), the observer can hold it in their hands and observe the digital image content on the digital video screen component of the device.

### EXAMPLE 3: GREETING CARD APPLICATIONS

Certain embodiments of this invention include a greeting card sized application Embodiments of the greeting card application are a device that includes at least one digital video screen component for displaying digital image content. Other components may include one or more computer devices, one or more memory devices, and/or one or more input devices to load and store the digital image content and/or instructions on the device, and then transfer the digital image content to the at least one digital video screen component for eventual display. The device may also include one or more control devices that are used to, for example, turn it on and off, and a housing to attach and/or connect all of the components. Alternatively, the at least one digital video screen components may have all of the other components built into it, including any computer devices, any memory devices, any input devices, and any control devices, and thus it will not include a separate housing.

In certain preferred embodiments the dimensions of the greeting card devices is approximately 5″×7″ and approximately ⅛″ thick. The contents of the digital image content used for the greeting cards can be of a wide variety of topics, including of subject matter often used in conventional paper greeting cards.

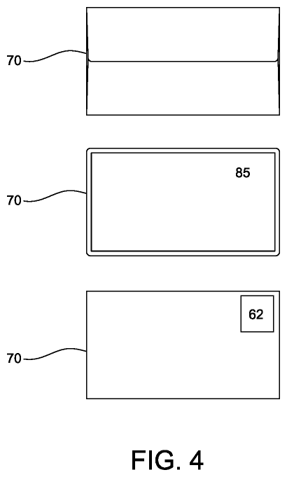

FIG. 4 shows a schematic of an embodiment of a greeting card application of this invention with a front 60 view of an envelope (with an area for a stamp 62), a back 70 view of an envelope, and a front 70 view of the greeting card with a digital video screen component 85 that is the entire size of the greeting card. The back side of the greeting card (not shown), can contain a message to the observer (e.g., Happy Birthday, Congratulations on your Graduation, Happy Retirement, New Baby Boy, New Job, Sorry for your Loss, and other words of hope, meaning, expression, humor, best wishes, etc.).

In certain of the most preferred embodiments of the greeting card application of this invention, the greeting card device is capable of displaying digital image content, the digital image content comprising animations, pictures, in-motion images, slide shows, and video and audio. The greeting card device comprises (a) a size of approximately 5″×7″ and the device is approximately ⅛″ thick (other sizes and shapes can be used); (b) a digital video screen component, which is capable of displaying the digital image content for an observer to see; (c) an input device, which is capable of receiving the digital image content and sending it to a computer device; (d) a memory device, which is capable of storing the digital image content after receiving such from the computer device; (e) the computer device, which is capable of receiving the input of digital image content from the input device, which is also capable of outputting the digital image content to the memory device, and which is also capable of retrieving the digital image content from the memory device and sending it to the digital video screen component; (f) a control device, which is capable of turning the greeting card device on; and (g) wherein once the greeting card device is turned on, the computer device retrieves the digital image content from the memory device and sends it to the digital video screen component for display to the observer. The greeting card device may be provided with a protective envelope, the digital video screen component can be protected by a flap, or other variations can be provided.

In addition, to avoid any doubt, in the greeting card applications of this invention, the informational card devices are processed by the user to provide information concerning the user or a topic (e.g., subject matter) of interest to the user, and once completed, are given away to an observer as the intended recipient of the information concerning the user or a topic of interest to the user. In other words, in these particular applications, the user is preparing the device to be used by another person or persons, i.e., the observer or the observers. For example, by using the term “greeting card” herein, the inventor is referring to a new device that may replace the use of traditional paper “greeting cards” that are mailed out (or handed) to people of interest without charge and without expectation of having them returned. The inventor is not referring to a tool a user may use personally in their business or personal life—i.e., the greeting card devices are intended to be used by observers.

The user can mail the greeting card device to a potential observer, and, because it is self-contained (e.g., in use by the observer it does not need to be plugged in or connected to wires to anything else), the observer can hold it in their hands and observe the digital image content on the digital video screen component of the device.

### EXAMPLE 4: CALENDAR APPLICATIONS

Certain embodiments of this invention include a calendar application. Embodiments of the calendar application are a device that includes at least one digital video screen component for displaying digital image content (which, as defined above, includes video with audio). Other components may include one or more computer devices, one or more memory devices, and/or one or more input devices to load and store the digital image content and/or instructions on the device, and then transfer the digital image content to the at least one digital video screen component for eventual display. The device may also include one or more control devices that are used to, for example, turn it on and off, and a housing to attach and/or connect all of the components. Alternatively, the at least one digital video screen components may have all of the other components built into it, including any computer devices, any memory devices, any input devices, and any control devices, and thus it will not include a separate housing.

In certain preferred embodiments, the calendar application will provide a digital video screen component on a frame (otherwise referred to as a “card” herein) above a paper calendar. In operation in these embodiments, the digital video screen component can be programmed to play a video reminder at a certain time and/or date that can be also noted on the paper calendar below it by the observer of the video.

In some embodiments, a button (i.e., a control device) to activate the calendar device will preferably be at the top right or left or bottom left or right of the device. The material composition of the calendar device of these embodiments is preferably cardboard-like or plastic with either a dull or shiny finish.

The preferred dimensions of the calendar devices are W10″×L14″ or larger or smaller depending on the final dimensions desired. The preferred bottom of the calendar device can be ordered each year to replace the previous year. The preferred bottom of the calendar device can be detached/removed and replaced with another calendar put in its place by attaching it to the calendar device by an adhesive (e.g., use of an adhesive strip) or other attachment hardware (e.g., a magnet, a clip, a picture hanger). The preferred dimensions of the calendar device are approximately 1/16″ to ⅛″. The preferred dimensions of the digital video screen component are approximately W 3⅝″×4″ but can be larger or smaller depending on the final dimensions desired, including considerations concerning whether any other components require space inside the device.

Preferably, perforated calendar sheets for each month of a 12-month period are located approximately two inches below the digital video screen component. Weekly calendars can also be used. In some embodiments, there are two options for each year: A section to write in the year or a digital space to display the year.

In some embodiments, the calendar device has perforated sheets that reflect the weeks and each day of the week that can be torn off at the end of each month (or week). In other embodiments, there are two calendar options: one from January to December and a fiscal year that business/professionals use to assist them with their appointments, events, meetings and travels as well as personal appointments. The calendar sheets of this embodiment have both numeral and squares for writing information in them or just a number for each day of the week which makes it more flexible/versatile/adaptable according to one's needs.

In other embodiments, the digital video screen component is at the top of the device and the monthly and weekly sheets display numbers within the squares for each day, and notations can be made inside the squares, like many paper calendars that are in common use, with perforated sheets for each month. Alternatively, in some embodiments the calendar below the digital video screen component is a white board (or blackboard or any other color) that can be erased each month. In some embodiments, the digital video screen component is used to disply reminders of appointments at particular times and/or dates that have been loaded into the device (e.g., through an input device) and set by the user.

In certain embodiments, the calendar device has a magnet and/or hook on the back which allows the calendar to attach to a refrigerator, a wall, a door, or any other stable or convenient object and, if desired, it can be removed and placed (displayed) on a desk or any area one desires to put it.

In some embodiments, the calendar device is preferably about ⅛″ to 3/16″ of an inch in thickness. The digital video screen component window size is preferably about W 3⅝″×L 4″ but it can be larger or smaller depending on the components contained in the device. The digital video screen component is embedded into the material of the calendar device's base, which is preferably cardboard or plastic, and the device is capable of playing videos that are uploaded into it by the user.

In some preferred embodiments, the calendar device frame or housing is plastic and it contains a white board surface below the digital video screen component that at the end of the month can be erased. The squares of the calendar stay intact along with the Sunday to Saturday headings. The back of the calendar will have either a hook to secure it to the wall or magnet to secure it to a refrigerator, or other desired surfaces.

An advantage of the calendar applications of this invention is that people are less likely to forget an appointment when a video is played to remind them of one (e.g., playing a video as a reminder or at a set time, similar to an alarm). Parents, children, other family members or caretakers can leave video reminders of school events and appointments, doctors appointments, personal errands, shopping lists, leave heart-felt messages for one another, and schedule all appointments or events that come up in day to day life. Such assistance to the organizations of busy lives with this digital, animated, video calendar is advantageous to help simplify lives and ease anxiety. If a person tends to forget things, these video options provided by this invention can be uploaded to remind one or the family of important events. In this regard, a message from a smartphones/tablet/iPad can be sent to and be input into the digital calendar device. The device can also be programmed to plays favorite music and operate as an alarm.

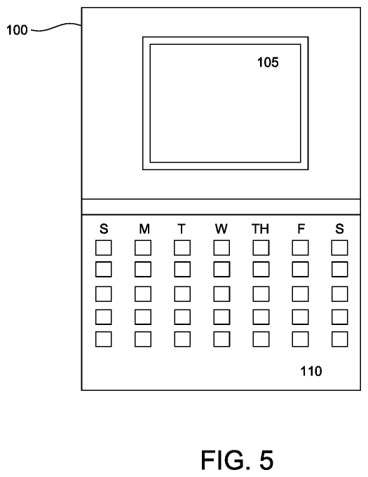

FIG. 5 shows a schematic of an embodiment of a calendar card 100 application of this invention with a front view with a digital video screen component 105 on the top part and a white board calendar form 110 on the bottom part. The white board calendar form 110 of this embodiment is a “universal calendar” where a user can print in the dates for the particular month at hand in the squares that are shown for each day of the week. In alternative embodiments (not shown), the dates for the particular months (or weeks, or days, etc.) can be printed on tear off paper sheets for each time period. More or less space for taking notes can be provided to the user depending on their desires.

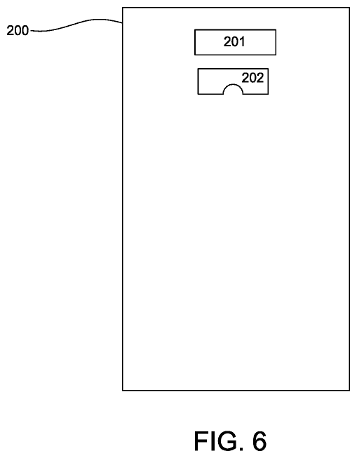

FIG. 6 shows a schematic of an embodiment of a calendar card application of this invention with a back 200 view with an adhesive strip 201 and hanging hardware (a picture hanger piece 202) on the top. Other hardware can be used to display or hold the calendar card (e.g., a tripod, a leg for the back to lean the card into, a magnet, etc.).

In certain of the most preferred embodiments of the calendar card application of this invention, the calendar card device is capable of displaying digital image content, the digital image content comprising animations, pictures, in-motion images, slide shows, and video and audio. The calendar card device comprises (a) a size of approximately 10″×14″ and the device is approximately ⅛″ thick (other sizes and shapes can be used); (b) a digital video screen component, which is capable of displaying the digital image content for an observer to see (e.g., of a dimension of 3⅝″×4″ in some embodiments, but other sizes can be used); (c) an input device, which is capable of receiving the digital image content and sending it to a computer device; (d) a memory device, which is capable of storing the digital image content after receiving such from the computer device; (e) the computer device, which is capable of receiving the input of digital image content from the input device, which is also capable of outputting the digital image content to the memory device, and which is also capable of retrieving the digital image content from the memory device and sending it to the digital video screen component; (f) a control device, which is capable of turning the greeting card device on; and (g) wherein once the calendar card device is turned on, the computer device retrieves the digital image content from the memory device and sends it to the digital video screen component for display to the observer. In addition, attached to the calendar card device is a calendar, in the form of a paper calendar, a white board, a black board, some other color board, or some other form of a calendar.

### EXAMPLE 5: OTHER APPLICATIONS

There are many other applications of this invention. In each of these applications, embodiments of this invention provide a device that includes at least one digital video screen component for displaying digital image content (which, as defined above includes video and audio). Other components may include one or more computer devices, one or more memory devices, and/or one or more input devices to load and store the digital image content and/or instructions on the device, and then transfer the digital image content to the at least one digital video screen component for eventual display. The device may also include one or more control devices that are used to, for example, turn it on and off, and a housing to attach and/or connect all of the components. Alternatively, the at least one digital video screen components may have all of the other components built into it, including any computer devices, any memory devices, any input devices, and any control devices, and thus it will not include a separate houseing.

These other applications include a magazine or book advertisement insert card made with a relatively thin (e.g., about 1/16″ to about ⅛″ in preferred embodiments) front and back, the front and back made out of cardboard and/or other material, and containing the digital video screen component and any other components of this invention between the cardbaord (and/or other material) front and back. This magazine or book advertisement insert card will work in a manner similar to the business, post, greeting, and calendar cards described in Examples 1-4 above. The magazine or book advertisement insert card is attached to the spine of the magazines like other advertisements that are glued and/or stapled to the spine of the book/magazine and they can be pulled out/detached from the book/magazine by an observer. The magazine insert cards are most preferably of about the same width and length as conventional magazine insert cards (e.g., 5″×7″).

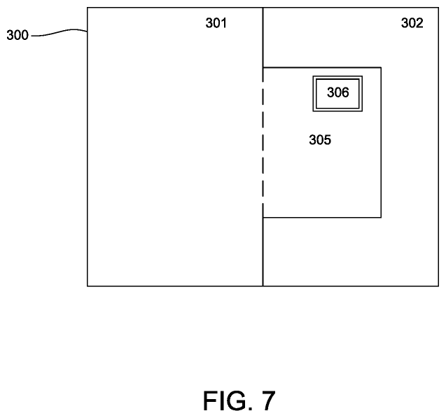

FIG. 7 shows a schematic of an embodiment of a magazine insert card application of this invention with a front 300 view of an open magazine, showing a left side 301 and a right side 302, with the magazine insert card 305 attached to the seam (shown in the middle) of the magazine. In this particular embodiment, the magazine insert card 305 can be ripped out of the magazine and a video played from a digital video screen component 306 in the insert. In other embodiments, the magazine insert card is held onto the magazine by a perforated portion that can be torn to release the insert.

Other applications include applying the digital video screen component (and the other components of this invention as needed) to dishes (e.g., a coffee mug that displays digital image content on the side); clothing (e.g., a T-Shirt that displays digital image content on the front pocket area); hats (e.g., a ball cap that displays digital image content on the front); kid's toys (e.g., a teddy bear that displays digital image content on its front area); wallets (e.g., that displays digital image content (such as a reminder)); school supplies (e.g., a notebook or journal that displays digital image content on its front, such as a class schedule); a key chain (e.g., that displays digital image content like the identify of the lock that fits the key or reminders). Any of these devices can be used to send uplifting, encouraging words and reminders to help people (e.g., kids going to school) get through the day, especially anyone having to deal with difficulties such as bullying, exams and anxiety. It is comforting to hear from mom, dad, siblings, grandma and grandpa and others so that people do not feel alone. These and other categories of different products can be used with this invention.

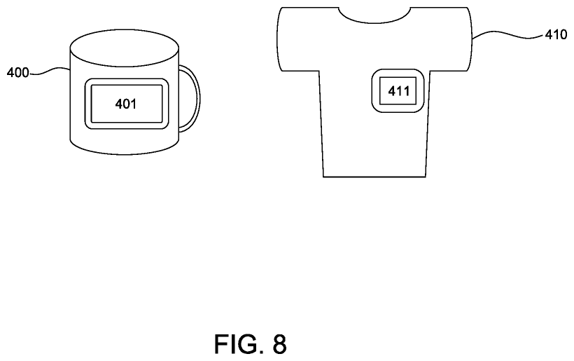

FIG. 8 shows schematics of two embodiments of the invention, namely a mug 400 and a T-Shirt 410, each of which have at least one digital video screen component and cards (401, 411) of this invention.

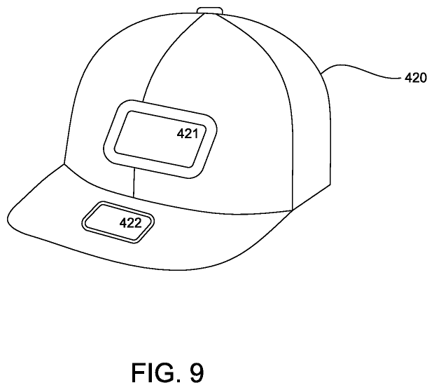

FIG. 9 shows schematics of one embodiment of the invention, namely a cap 420, that has at two digital video screen components and cards (421, 422) of this invention.

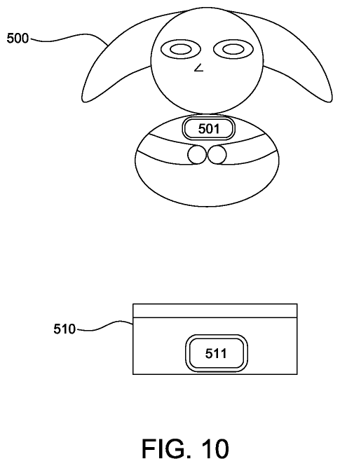

FIG. 10 shows schematics of two embodiments of the invention, namely a doll 500 (e.g., teddy bear), and an inside view of a wallet 510, each of which have at least one digital video screen component and cards (501, 511) of this invention.

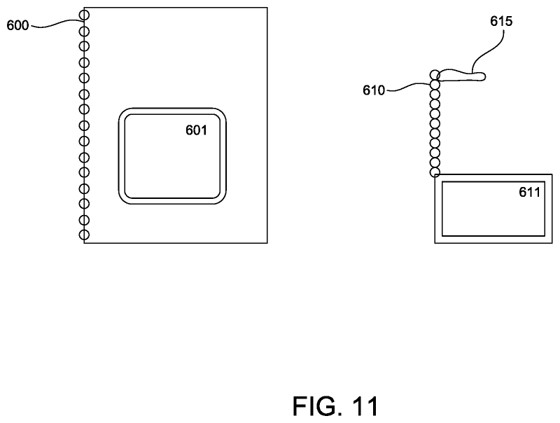

FIG. 11 shows schematics two embodiments of the invention, namely a notebook 600 (e.g., a notebook/journal for school), and a key chain 610 with a chain and hook 615, each of which have at least one digital video screen component (601, 611) and cards of this invention.

### Particular Applications Using Computer Devices

The invention may include a plurality of different computer device types such as a computer device that is a hardware device (e.g., a device with integrated circuits and other components) installed on the card embodiments or a similar device that contains instructions and/or digital image content that are to be loaded on to the cards. In general, a computer device type that may contain the instructions and/or digital image content to be loaded on to the cards may be a computer system or computer server. The computer device may be described in the general context of computer system executable instructions, such as program modules, being executed by a computer system (described for example, below). In some embodiments, the computer device may be a cloud computing node (for example, in the role of a computer server) connected to a cloud computing network (not shown). The computer device may be practiced in distributed cloud computing environments where tasks are performed by remote processing devices that are linked through a communications network. In a distributed cloud computing environment, program modules may be located in both local and remote computer system storage media including memory storage devices.

The computer device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the computer device component of the invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer device that is a computer program product embodied in one or more computer readable media having computer readable program code embodied thereon.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. An informational card device that is capable of displaying digital image content, the digital image content comprising animations, pictures, in-motion images, slide shows, and/or video and audio, the informational card device comprising:
(a) one or more digital video screen components, which are devices that are capable of displaying the digital image content for an observer to see;
(b) one or more input devices, which are devices that are capable of receiving the digital image content and sending it to one or more computer devices;
(c) one or more memory devices, which are devices that are capable of storing the digital image content after receiving such from the one or more computer devices;
(d) the one or more computer devices, which are capable of receiving the input of digital image content from the one or more input devices, which are also capable of outputting the digital image content to the one or more memory devices, and which are also capable of retrieving the digital image content from the one or more memory devices and sending it to the one or more digital video screen components;
(e) one or more control devices, which are capable of turning the informational card device on;
(f) wherein once the informational card device is turned on, the one or more computer devices retrieves the digital image content from the one or more memory devices and sends it to the one or more digital video screen components for display to the observer;
(g) the type of informational card device is selected from the group consisting of business cards, post cards, greeting cards, calendar cards, card attachments to dishes, card attachments to clothing, card attachments to kid's toys, card attachments to wallets, card attachments to school supplies, or card attachments to key chains;
(h) if the informational card device is a business card device, post card device, greeting card device, or magazine insert card device, then the digital image content is provided by or for the benefit of a user and the digital image content concerns the user or subject matter of interest to the user that the user wants the observer to see; and
(i) the informational card device is portable, self-contained and of a size of less than about W12″×L12″ and less than about ½″ thick.

2. A business card device that is capable of displaying digital image content, the digital image content comprising animations, pictures, in-motion images, slide shows, and/or video and audio, the business card device comprising:
(a) a size of approximately 2″×3.5″ and the device is approximately ⅛″ thick;
(b) a digital video screen component, which is capable of displaying the digital image content for an observer to see;
(c) an input device, which is capable of receiving the digital image content and sending it to a computer device;
(d) a memory device, which is capable of storing the digital image content after receiving such from the computer device;
(e) the computer device, which is capable of receiving the input of digital image content from the input device, which is also capable of outputting the digital image content to the memory device, and which is also capable of retrieving the digital image content from the memory device and sending it to the digital video screen component;
(f) a control device, which is capable of turning the business card device on;
(g) wherein once the business card device is turned on, the computer device retrieves the digital image content from the memory device and sends it to the digital video screen component for display to the observer;
(h) the digital image content is provided by or for the benefit of a user and the digital image content concerns the user or subject matter of interest to the user that the user wants the observer to see; and
(i) the business card device is self-contained and capable of being handed to the observer who can then observe the digital image content on the digital video screen component of the device.

3. A post card device that is capable of displaying digital image content, the digital image content comprising animations, pictures, in-motion images, slide shows, and/or video and audio, the post card device comprising:
(a) a size of approximately 3.18″×5.6″ and the device is approximately ⅛″ thick;
(b) a digital video screen component, which is capable of displaying the digital image content for an observer to see;
(c) an input device, which is capable of receiving the digital image content and sending it to a computer device;
(d) a memory device, which is capable of storing the digital image content after receiving such from the computer device;
(e) the computer device, which is capable of receiving the input of digital image content from the input device, which is also capable of outputting the digital image content to the memory device, and which is also capable of retrieving the digital image content from the memory device and sending it to the digital video screen component;
(f) a control device, which is capable of turning the post card device on;
(g) wherein once the post card device is turned on, the computer device retrieves the digital image content from the memory device and sends it to the digital video screen component for display to the observer;
(h) the digital image content is provided by or for the benefit of a user and the digital image content concerns the user or subject matter of interest to the user that the user wants the observer to see; and
(i) the post card device is self-contained and capable of being mailed to the observer who can then observe the digital image content on the digital video screen component of the device.

4. A greeting card device that is capable of displaying digital image content, the digital image content comprising animations, pictures, in-motion images, slide shows, and/or video and audio, the greeting card device comprising:
(a) a size of approximately 5″×7″ and the device is approximately ⅛″ thick;
(b) a digital video screen component, which is capable of displaying the digital image content for an observer to see;
(c) an input device, which is capable of receiving the digital image content and sending it to a computer device;
(d) a memory device, which is capable of storing the digital image content after receiving such from the computer device;
(e) the computer device, which is capable of receiving the input of digital image content from the input device, which is also capable of outputting the digital image content to the memory device, and which is also capable of retrieving the digital image content from the memory device and sending it to the digital video screen component;
(f) a control device, which is capable of turning the greeting card device on;
(g) wherein once the greeting card device is turned on, the computer device retrieves the digital image content from the memory device and sends it to the digital video screen component for display to the observer;
(h) the digital image content is provided by or for the benefit of a user and the digital image content concerns the user or subject matter of interest to the user that the user wants the observer to see; and
(i) the greeting card device is self-contained and capable of being mailed to the observer who can then observe the digital image content on the digital video screen component of the device.

5. A calendar card device that is capable of displaying digital image content, the digital image content comprising animations, pictures, in-motion images, slide shows, and/or video and audio, the greeting card device comprising:
(a) a size of approximately 10″×14″ and the device is approximately ⅛″ to ¼″ thick;
(b) a digital video screen component, which is capable of displaying the digital image content for an observer to see, and which is preferably of a size of approximately 3⅝″×4″;
(c) an input device, which is capable of receiving the digital image content and sending it to a computer device;
(d) a memory device, which is capable of storing the digital image content after receiving such from the computer device;
(e) the computer device, which is capable of receiving the input of digital image content from the input device, which is also capable of outputting the digital image content to the memory device, and which is also capable of retrieving the digital image content from the memory device and sending it to the digital video screen component;
(f) a control device, which is capable of turning the calendar card device on;
(g) wherein once the calendar card device is turned on, the computer device retrieves the digital image content from the memory device and sends it to the digital video screen component for display to the observer;
(h) a paper calendar attached to the calendar card device, positioned below the digital video screen component;
(i) the digital image content is provided by or for the benefit of a user and the digital image content concerns the user or subject matter of interest to the user that the user wants the observer to see; and
(j) the calendar card device is self-contained and capable of being handed to the observer who can then observe the digital image content on the digital video screen component of the device.

6. An informational card device that is capable of displaying digital image content, the digital image content comprising animations, pictures, in-motion images, slide shows, and/or video and audio, the informational card device comprising:
(a) one or more digital video screen components, which are devices that are capable of displaying the digital image content for an observer to see;
(b) one or more input devices, which are devices that are capable of receiving the digital image content and sending it to one or more computer devices;
(c) one or more memory devices, which are devices that are capable of storing the digital image content after receiving such from the one or more computer devices;
(d) the one or more computer devices, which are capable of receiving the input of digital image content from the one or more input devices, which are also capable of outputting the digital image content to the one or more memory devices, and which are also capable of retrieving the digital image content from the one or more memory devices and sending it to the one or more digital video screen components;
(e) one or more control devices, which are capable of turning the informational card device on;
(f) wherein once the informational card device is turned on, the one or more computer devices retrieves the digital image content from the one or more memory devices and sends it to the one or more digital video screen components for display to the observer; and
(g) wherein the informational card is portable, self-contained and with a thickness of about 1/16″ to about ½″ and with a size of the digital video screen component of less than about W12″×L12″.
